(19) United States
(12) Patent Application Publication
(10) Pub. No.: US 2026/0058534 A1
(43) Pub. Date: Feb. 26, 2026

(54) MANUFACTURING METHOD FOR LAMINATED CORE

(71) Applicant: KURODA PRECISION INDUSTRIES LTD., Kawasaki-shi, Kanagawa (JP)

(72) Inventor: Akio TAKEUCHI, Kanagawa (JP)

(21) Appl. No.: 19/103,403

(22) PCT Filed: Apr. 7, 2023
(86) PCT No.: PCT/JP2023/014363

§ 371 Date: Feb. 12, 2025

(51) Int. Cl. H02K 15/121; H02K 15/0273

(52) U.S. Cl. CPC H02K 15/121; H02K 15/0273; H02K 2201/09; H02K 2215/00

(57) ABSTRACT

A primary adhesive agent is applied to a core laminate in which separation layers are interposed between multiple blocks each consisting of a predetermined number of core constituting plates, the separation layers are removed after the primary adhesive agent is cured, a secondary adhesive agent is applied to lamination surfaces between the blocks, and the secondary adhesive agent is cured.

### TECHNICAL FIELD

The present invention relates to a manufacturing method for a laminated core formed by stacking and adhesive bonding.

### BACKGROUND ART

As a laminated core used in a stator for a motor, a laminated core formed by stacking and adhesively bonding multiple core constituting plates, each consisting of a thin plate, is known. The laminated core formed by stacking and adhesive bonding has an adhesive agent layer between each pair of core constituting plates that are adjacent to each other in the stacking direction. (for example, Patent Document 1).

### PRIOR ART DOCUMENT(S)

### Patent Document(s)

Patent Document 1: JP6868719B1

### SUMMARY OF THE INVENTION

### Task to Be Accomplished by the Invention

In the laminated core formed by stacking and adhesive bonding, the adhesive agent layers contract when cured, and as a result, stress is generated in the core constituting plates. Due to this stress, the laminated core deforms to be convex in the stacking direction. Therefore, a phenomenon is observed that the larger the number of the stacked core constituting plates is, the greater the laminated core formed by stacking and adhesive bonding deforms to be concave.

In view of the foregoing background, an object of the present invention is to make it possible to manufacture a laminated core formed by stacking and adhesive bonding with reduced deformation even if the laminated core has a large number of laminations.

### Means to Accomplish the Task

To achieve the above object, one aspect of the present invention provides a manufacturing method for a laminated core in which multiple core constituting plates are stacked and adhesively bonded, the manufacturing method comprising: a core constituting plate creating step of creating multiple core constituting plates, each having a predetermined shape, from a thin plate; a core laminate forming step of forming a core laminate by stacking the core constituting plates such that, for each of multiple blocks each consisting of a predetermined number of the core constituting plates, a separation layer is interposed between adjacent ones of the core constituting plates; a primary adhesion step of applying a primary adhesive agent to the core laminate while the core laminate is held by a first holding jig; a primary adhesive agent curing step of curing the primary adhesive agent while the core laminate is held by the first holding jig; a separation layer removal step of removing the separation layers; a secondary adhesion step of applying a secondary adhesive agent to lamination surfaces between the blocks; and a secondary adhesive agent curing step of curing the secondary adhesive agent while the core laminate is held by a second holding jig.

According to this aspect, manufacture of a laminated core formed by stacking and adhesive bonding with reduced deformation becomes possible even if the laminated core has a large number of laminations.

Note that applying the primary adhesive agent to the thin plate laminate includes forming an adhesive agent layer on the lamination surface of each of the thin plates constituting the thin plate laminate. Also, applying the secondary adhesive agent to the lamination surfaces between the blocks includes forming an adhesive agent layer on the lamination surfaces between the blocks. The primary adhesive agent and the secondary adhesive agent may be adhesive agents having an identical composition. Also, the first holding jig and the second holding jig may be jigs having an identical structure.

In the above aspect, holding of the core laminate by the first holding jig and the second holding jig may be performed in a state in which the core laminate is pressed in a stacking direction while displacement in a direction perpendicular to the stacking direction is restricted.

According to this aspect, the core laminate is created with high precision. Moreover, the laminated core is created with high precision.

In the above aspect, the primary adhesion step may include a step of immersing the core laminate in an adhesive agent bath containing the primary adhesive agent in a liquid state and a step of reducing pressure inside the adhesive agent bath.

According to this aspect, the application of the primary adhesive agent to the core laminate is performed favorably.

Also, to achieve the above object, one aspect of the present invention provides a manufacturing method for a laminated core in which multiple core constituting plates are stacked and adhesively bonded, the manufacturing method comprising: a thin plate stacking step of forming a thin plate laminate by stacking thin plates such that, for each of multiple blocks each consisting of a predetermined number of the thin plates, a separation layer is interposed between adjacent ones of the thin plates; a primary adhesion step of applying a primary adhesive agent to the thin plate laminate while the thin plate laminate is held by a first holding jig; a primary adhesive agent curing step of curing the primary adhesive agent applied to the thin plate laminate while the thin plate laminate is held by the first holding jig; a core constituting body creating step of creating a core constituting body having a predetermined shape from the thin plate laminate; a separation layer removal step of removing the separation layers; a secondary adhesion step of applying a secondary adhesive agent to lamination surfaces between the blocks; and a secondary adhesive agent curing step of curing the secondary adhesive agent while the core constituting body is held by a second holding jig.

According to this aspect, manufacture of a laminated core formed by stacking and adhesive bonding with reduced deformation becomes possible even if the laminated core has a large number of laminations.

Note that applying the primary adhesive agent to the thin plate laminate includes forming an adhesive agent layer on the lamination surface of each of the thin plates constituting the thin plate laminate. Also, applying the secondary adhesive agent to the lamination surfaces between the blocks includes forming an adhesive agent layer on the lamination surfaces between the blocks. The primary adhesive agent and the secondary adhesive agent may be adhesive agents having an identical composition.

In the above aspect, holding of the thin plate laminate by the first holding jig may be performed in a state in which the thin plate laminate is pressed in a stacking direction while displacement in a direction perpendicular to the stacking direction is restricted, and holding of the core constituting body by the second holding jig may be performed in a state in which the core constituting body is pressed in the stacking direction while displacement in the direction perpendicular to the stacking direction is restricted.

According to this aspect, the thin plate laminate and the core constituting body are created with high precision. Moreover, the laminated core is created with high precision.

In the above aspect, the primary adhesion step may include a step of immersing the thin plate laminate in an adhesive agent bath containing the primary adhesive agent in a liquid state and a step of reducing pressure inside the adhesive agent bath.

According to this aspect, the application of the adhesive agent to the thin plate laminate is performed favorably.

In the above aspect, the core constituting body creating step may include an outer shape forming step that uses wire electrical discharge machining, electron beam machining, or laser beam machining.

According to this aspect, the creation of the core constituting body is performed favorably.

In the above aspect, the separation layer may include at least one selected from the group consisting of fluorine, silicon, wax, and oils and fats.

According to this aspect, an effect that it becomes difficult for the primary adhesive agent to adhere to the core constituting plate or the thin plate can be obtained favorably.

### EFFECT OF THE INVENTION

According to the forgoing aspect, manufacture of a laminated core formed by stacking and adhesive bonding with reduced deformation becomes possible even if the number of laminations is large.

### BRIEF DESCRIPTION OF THE DRAWINGS

FIG. 1 A perspective view of a laminated core manufactured by a manufacturing method for a laminated core according to a first embodiment

FIG. 2 An exploded perspective view of a main part of a holding jig for manufacture of the laminated core according to the first embodiment

FIG. 3 A flowchart showing a manufacturing process for the laminated core according to the first embodiment

FIG. 4 A perspective view showing a divided iron core piece creating step in the manufacturing method for the laminated core according to the first embodiment

FIG. 5 A perspective view showing an initial state of a stacking step in the manufacturing method for the laminated core according to the first embodiment

FIG. 6 A perspective view showing an initial state of a stacking step in the manufacturing method for the laminated core according to the first embodiment

FIG. 7 A perspective view showing a completed state of the step of stacking divided iron core pieces in the manufacturing method for the laminated core according to the first embodiment

FIG. 8 A perspective view showing an attached state of a pressing plate in the manufacturing method for the laminated core according to the first embodiment

FIG. 9 A perspective view showing a pressing step in the manufacturing method for the laminated core according to the first embodiment

FIG. 10 A sectional view showing a primary adhesion step in the manufacturing method for the laminated core according to the first embodiment

FIG. 11 A sectional view showing a primary adhesive agent cleaning step in the manufacturing method for the laminated core according to the first embodiment

FIG. 12 A perspective view showing replacement of bolts of a first holding jig in the cleaning step of the manufacturing method for the laminated core according to the first embodiment

FIG. 13 A sectional view showing a primary adhesive agent drying step in the manufacturing method for the laminated core according to the first embodiment

FIG. 14 A sectional view showing a separation layer removal step in the manufacturing method for the laminated core according to the first embodiment

FIG. 15 A sectional view showing a secondary adhesion step in the manufacturing method for the laminated core according to the first embodiment

FIG. 16 A sectional view showing a secondary adhesive agent cleaning step in the manufacturing method for the laminated core according to the first embodiment

FIG. 17 A sectional view showing a secondary adhesive agent drying step in the manufacturing method for the laminated core according to the first embodiment

FIG. 18 A flowchart showing a manufacturing process in a manufacturing method for a laminated core according to a second embodiment

FIG. 19 A perspective view showing a stacking step for a thin plate laminate in the manufacturing method for the laminated core according to the second embodiment

FIG. 20 A perspective view showing a thin plate laminate pressing step in the manufacturing method for the laminated core according to the second embodiment

FIG. 21 A perspective view showing a core laminate creating step in the manufacturing method for the laminated core according to the second embodiment

FIG. 22 A perspective view showing a core laminate created by the manufacturing method for the laminated core according to the second embodiment

### MODE(S) FOR CARRYING OUT THE INVENTION

In the following, embodiments of the present invention will be described with reference to the drawings.

### First Embodiment

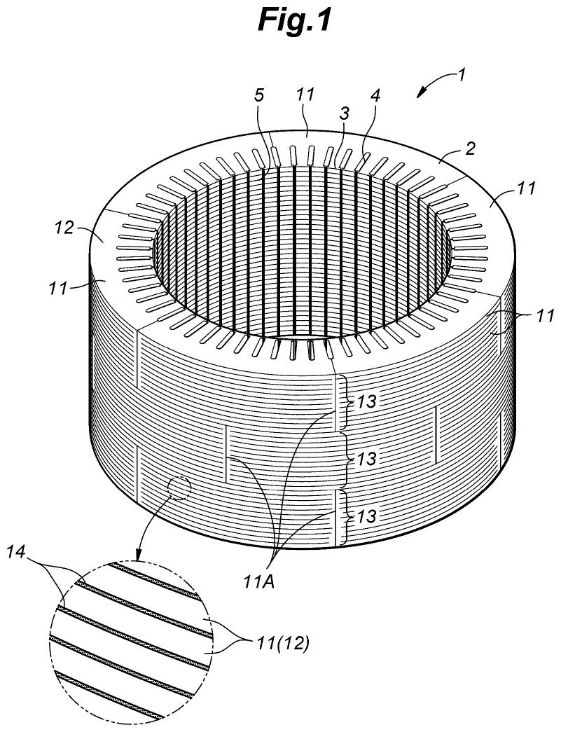

FIG. 1 is a perspective view of a laminated core 1 manufactured by a manufacturing method for a laminated core according to a first embodiment. In the present embodiment, the laminated core 1 will be described taking a stator for a motor as an example.

As shown in FIG. 1, the laminated core 1 has a tubular shape and includes an annular yoke 2 and multiple teeth 3 formed to protrude inward from the yoke 2. The multiple teeth 3 are arranged to be spaced from each other at a predetermined interval in the circumferential direction. Slots 4 are formed between the teeth 3 that are adjacent to each other in the circumferential direction. Each slot 4 penetrates the laminated core 1 in the axial direction (the up-down direction in FIG. 1). At the center of the laminated core 1, a substantially circular center hole 5 is formed. The center hole 5 penetrates the laminated core 1 in the axial direction. In the center hole 5, a rotor for a motor (not shown in the drawings) is disposed.

The laminated core 1 is composed of multiple core constituting plates 12 each of which has a circular annular shape and which are stacked and adhesively bonded to each other. Each core constituting plate 12 is formed by connecting a predetermined number of (six in the present embodiment) divided iron core pieces 11, which are divided in the circumferential direction, to each other in the circumferential direction. Each divided iron core piece 11 corresponds to a piece obtained by dividing the annular core constituting plate 12 into six pieces along dividing lines that extend in the radial direction to pass the center and are separated from each other by 60 degrees. As shown by a partial enlargement view in FIG. 1, the divided iron core pieces 11 that are adjacent to each other in the stacking direction are joined by adhesive agent layers 14. The adhesive agent layers 14 are configured by later-described primary adhesive agent 86. The divided iron core pieces 11 that are adjacent to each other in the circumferential direction are joined by the later-described primary adhesive agent 86.

The laminated core 1 is constituted of a combination of multiple, three in the present embodiment, blocks 13 divided in the stacking direction of the core constituting plates 12.

Boundaries 11A between the divided iron core pieces 11 in each block 13 are positioned such that the boundaries 11A in vertically adjacent blocks 13 are at different positions in the circumferential direction. For example, relative to the lowermost block 13, the block 13 positioned above it (namely, the second block from below) has the boundaries 11A between the divided iron core pieces 11 at positions shifted 30 degrees (namely, a half of the division angle of each divided iron core piece 11) in the circumferential direction.

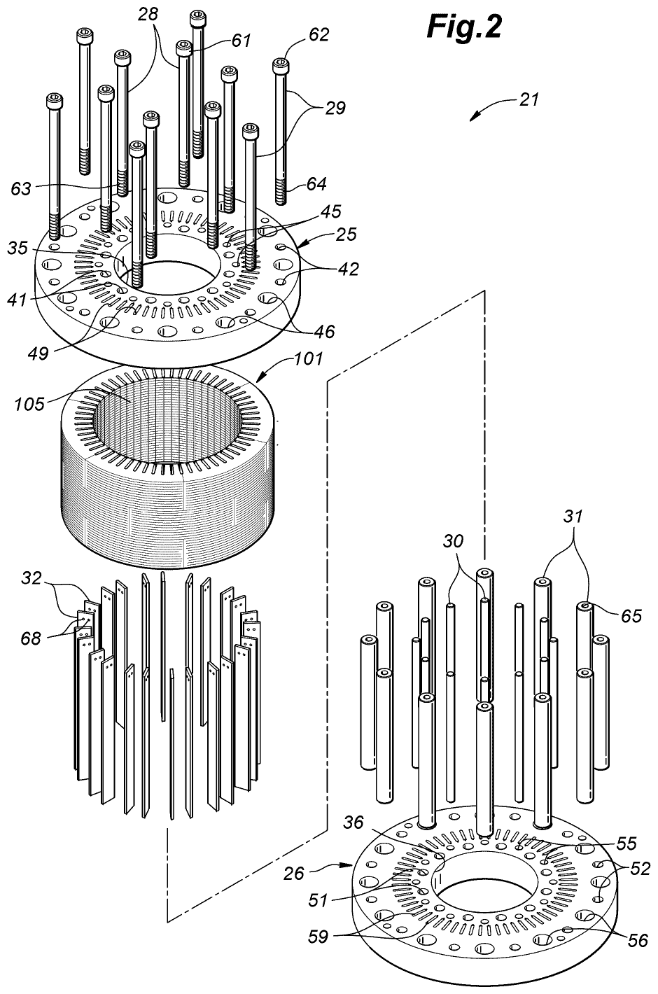

FIG. 2 shows a main part of a holding jig (first holding jig) 21 for manufacture of the laminated core 1 according to the first embodiment and a core laminate 101 held by the holding jig 21. In the present embodiment, the holding jig 21 also functions as a later-described second holding jig which is used after removal of separation layers 100.

An upper plate 25 is provided to sandwich the core laminate 101 in the axial direction (the up-down direction in FIG. 2) jointly with a lower plate 26. The upper plate 25 is an annular body having a substantially circular annular shape in plan view. The upper plate 25 has a center opening 35 provided to overlap with a center hole 105 of the core laminate 101 (which corresponds to the center hole 5 of the laminated core 1 shown in FIG. 1). The center opening 35 has a diameter smaller than the center hole 105 and penetrates the upper plate 25 in the axial direction.

The upper plate 25 has a flat lower surface configured to contact an upper surface of the core laminate 101. An inner peripheral portion of the upper plate 25 is provided with multiple inner bolt holes 41 spaced from each other at a predetermined interval in the circumferential direction. Each inner bolt hole 41 is a through hole vertically penetrating the upper plate 25. Each inner bolt 28 is inserted in the corresponding inner bolt hole 41. The head 61 of each inner bolt 28 contacts the upper surface of the upper plate 25. In the present embodiment, the number of the inner bolts 28 is set to be a half of the number of the inner bolt holes 41. The inner bolts 28 are inserted in every other corresponding inner bolt hole 41.

Similarly, an outer peripheral portion of the upper plate 25 is provided with multiple outer bolt holes 42 spaced from each other at a predetermined interval in the circumferential direction. Each outer bolt hole 42 is a through hole vertically penetrating the upper plate 25. Each outer bolt 29 is inserted in the corresponding outer bolt hole 42. The number of the outer bolts 29 is the same as the number of the inner bolts 28. In the present embodiment, the outer bolts 29 inserted in the respective outer bolt holes 42 are disposed in positions radially overlapping with the inner bolts 28 inserted in the respective inner bolt holes 41.

Further, the inner peripheral portion of the upper plate 25 is provided with multiple inner guide holes 45 spaced from each other at a predetermined interval in the circumferential direction. Each inner guide hole 45 is disposed in a middle position between the inner bolt holes 41 adjacent thereto in the circumferential direction. Each inner guide hole 45 is a through hole vertically penetrating the upper plate 25. An upper end portion of each inner guide post 30 is fitted in the corresponding inner guide hole 45. In the present embodiment, the number of the inner guide posts 30 and the number of the inner guide holes 45 are each twice the number of the inner bolts 28 (or the outer bolts 29).

Similarly, the outer peripheral portion of the upper plate 25 is provided with multiple outer guide holes 46 spaced from each other at a predetermined interval in the circumferential direction. Each outer guide hole 46 is disposed in a middle position between the outer bolt holes 42 adjacent thereto in the circumferential direction. Each outer guide hole 46 is a through hole vertically penetrating the upper plate 25. An upper end portion of each outer guide post 31 is fitted in the corresponding outer guide hole 46. In the present embodiment, the number of the outer guide posts 31 is the same as the number of the inner guide posts 30. The outer guide posts 31 are arranged in positions radially overlapping with the respective inner guide posts 30.

A radially intermediate portion of the upper plate 25 is provided with multiple slot correspondence holes 49 spaced from each other at a predetermined interval in the circumferential direction. Each slot correspondence hole 49 has a substantially same shape as each slot 4 of the laminated core 1 and is disposed in a position overlapping with each slot 4 in the axial direction. The number of the slot correspondence holes 49 is the same as the number of the slots 4. Each slot correspondence hole 49 is a through hole vertically penetrating the upper plate 25. An upper portion of each slot guide 32 is fitted in the corresponding slot correspondence hole 49. In the present embodiment, the number of the slot guides 32 is set to be less than the number of the slot correspondence holes 49. The slot guides 32 are inserted in every other or every third corresponding slot correspondence hole 49.

The lower plate 26 has a substantially same configuration as the upper plate 25. More specifically, the lower plate 26 has a center opening 36, inner bolt holes 51, outer bolt holes 52, inner guide holes 55, outer guide holes 56, and slot correspondence holes 59 which respectively correspond to the center opening 35, the inner bolt holes 41, the outer bolt holes 42, the inner guide holes 45, the outer guide holes 46, and the slot correspondence holes 49 of the upper plate 25. In the lower plate 26, the inner bolt holes 51 and the outer bolt holes 52 are formed as screw holes that respectively fit the threaded parts 63, 64 provided at the tips of the shaft portions of the inner bolts 28 and the outer bolts 29. The lower plate 26 has a flat upper surface configured to contact the lower surface of the core laminate 101.

Each inner bolt 28 is inserted through the inner bolt hole 41 of the upper plate 25, and the threaded part thereof is fixed to (namely, screwed into) the inner bolt hole 51 of the lower plate 26. At this time, the head 61 of each inner bolt 28 is locked to the upper surface of the upper plate 25. Also, the shaft portion of each inner bolt 28 extends between the upper plate 25 and the lower plate 26.

Each outer bolt 29 has a configuration similar to each inner bolt 28. Each outer bolt 29 is inserted through the outer bolt hole 42 of the upper plate 25 and the threaded part thereof is fixed to the outer bolt hole 52 of the lower plate 26. At this time, the head 62 of each outer bolt 29 is locked to the upper surface of the upper plate 25. Also, the shaft portion of each outer bolt 29 extends between the upper plate 25 and the lower plate 26.

Each inner guide post 30 has a substantially cylindrical columnar shape. An upper end portion and a lower end portion of each inner guide post 30 are respectively fitted into the inner guide hole 45 of the upper plate 25 and the inner guide hole 55 of the lower plate 26. Thereby, each inner guide post 30 is supported by the inner guide holes 45, 55. At this time, the intermediate portion of each inner guide post 30 extends between the upper plate 25 and the lower plate 26.

Each outer guide post 31 has a cylindrical columnar shape. Each outer guide post 31 has a larger outer diameter than each inner guide post 30 and has the same length as each inner guide post 30. An upper end portion and a lower end portion of each outer guide post 31 are respectively fitted into the outer guide hole 46 of the upper plate 25 and the outer guide hole 56 of the lower plate 26. Thereby, each outer guide post 31 is supported by the outer guide holes 46, 56. At this time, the intermediate portion of each outer guide post 31 extends between the upper plate 25 and the lower plate 26.

The upper end portion of each outer guide post 31 is provided with a screw hole 65 extending in the axial direction. A removal tool (not shown in the drawings) is fitted in the screw hole 65 when each outer guide post 31 is removed from the upper plate 25 and the lower plate 26.

Each slot guide 32 has a shape matching the slot 104 of the core laminate 101 (which corresponds to the slot 4 of the laminated core 1) in the horizontal section (namely, in plan view). Each slot guide 32 is only required to be capable of restricting at least the movement in the circumferential direction of the slot 104 and hence the divided iron core piece 11, when inserted in the slot 104. More specifically, the two side surfaces of the slot guide 32 in the circumferential direction respectively contact the two side surfaces of the slot 104 in the circumferential direction.

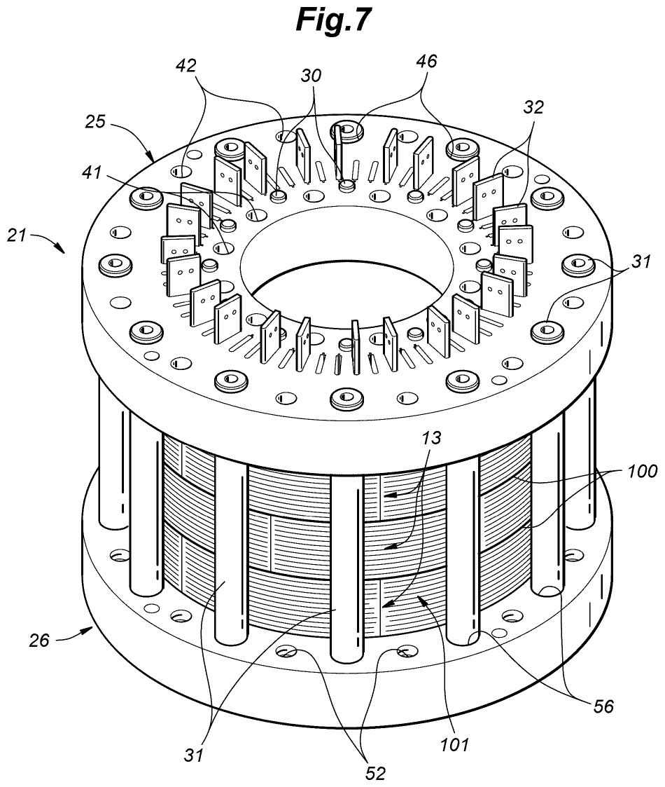

The upper portion and the lower portion of each slot guide 32 are respectively fitted into the slot correspondence hole 49 of the upper plate 25 and the slot correspondence hole 59 of the lower plate 26, with the intermediate portion of each slot guide 32 being inserted in the slot 104 of the core laminate 101. At this time, the upper portion of each slot guide 32 protrudes from the upper surface of the upper plate 25 (see FIG. 7). An upper portion of each slot guide 32 protruding from the upper surface of the upper plate 25 is provided with two locking holes 68. A removal tool (not shown in the drawings) is locked to each locking hole 68 when each slot guide 32 is removed.

Thus, with the inner guide posts 30, the outer guide posts 31, and the slot guides 32, the holding jig 21 restricts the displacement of the core laminate 101 placed on the lower plate 26 in the direction perpendicular to the stacking direction of the core laminate 101.

Note that the above-described configuration of the holding jig 21 may be changed as appropriate. For example, the upper plate 25 and the lower plate 26 do not need to be strictly plate-shaped, and it is only required that parts thereof function as plates that sandwich the core laminate 101 in the axial direction. The upper plate 25 and the lower plate 26 may be configured as block-shaped members. Further, for example, the sizes, shapes, and numbers of the inner guide posts 30, the outer guide posts 31, and the slot guides 32 may be changed as necessary.

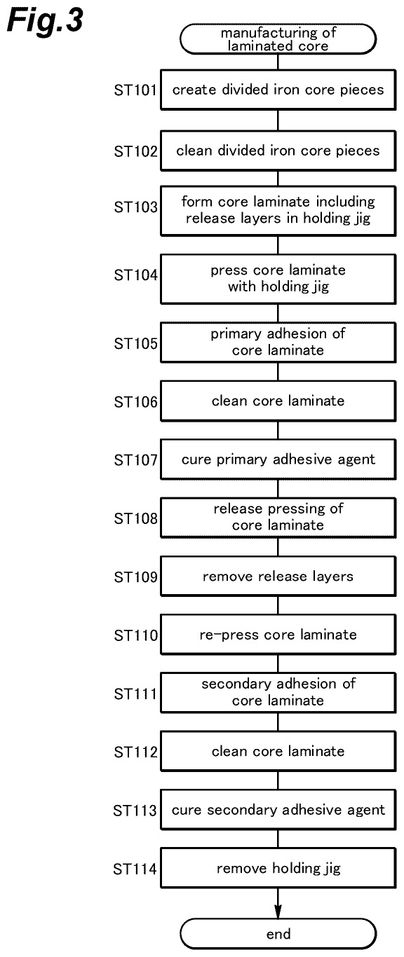

FIG. 3 is a flowchart showing a manufacturing process (ST101 to ST114) for the laminated core 1 according to the first embodiment.

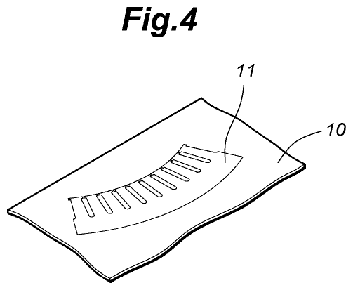

In the manufacturing process for the laminated core 1 of the first embodiment, first, as shown in FIG. 4, a step of creating the divided iron core pieces 11, which configure the core constituting plates 12, from a strip 10 (or coil material) by punching (hereinafter referred to as “the creating step”) is executed (ST101). In the creating step, punching press work of the strip 10, which is made of an electromagnetic steel sheet, is executed by using a known progressive die. Thereby, the multiple divided iron core pieces 11 are formed without being adhered to each other (namely, in a disjoined state). The plate thickness of each divided iron core piece 11 is not particularly limited, but may be set to be relatively thin (for example, 0.05 mm).

Note that the way of creating the divided iron core pieces 11 is not limited to press working, and by another known method such as wire electrical discharge machining, laser beam machining, etc. may be used.

Next, a step of cleaning the multiple divided iron core pieces 11 obtained by the creating step (hereinafter referred to as an iron core piece cleaning step) is executed (ST102). In the iron core piece cleaning step, each divided iron core piece 11 is degreased and cleaned by using a known solvent (for example, acetone, thinner, organic solvent, cleaning solvent, etc.). More specifically, the divided iron core pieces 11 are immersed in the solvent in the cleaning container, and the divided iron core piece 11 are vibrated by ultrasonic wave while the inside of the cleaning container is vacuumed. Thereby, substances adhered to the divided iron core piece 11 (such as press working oil used in the punching step) are removed.

Note that in the iron core piece cleaning step, the divided iron core pieces 11 may be cleaned by using other known methods. Also, in a case where the adhered substances do not affect the adhesion between the divided iron core pieces 11, the iron core piece cleaning step may be omitted.

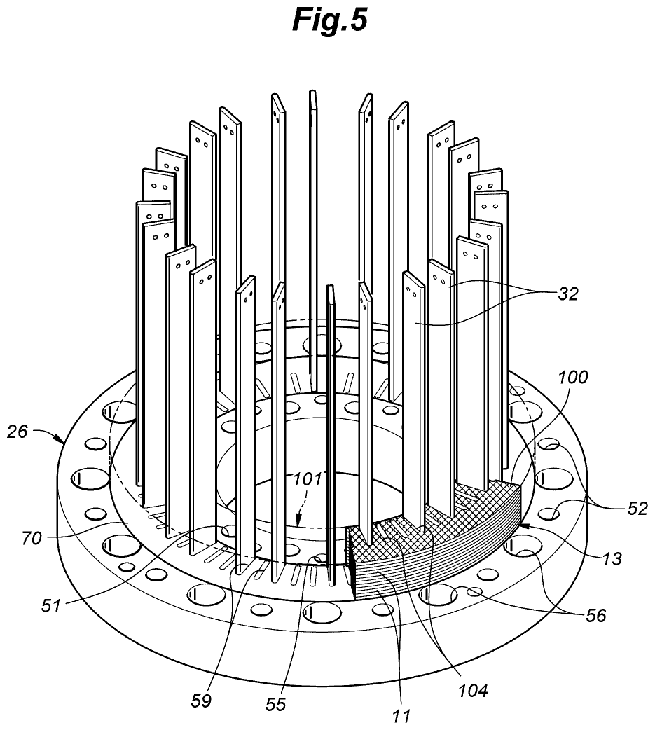

Next, as shown in FIG. 5, a core laminate forming step is executed where the core constituting plates 12 each configured by six divided iron core pieces 11 are stacked on the lower plate 26 of the holding jig 21 so that each time a predetermined number of core constituting plates 12 are stacked, a separation layer 100, which is indicated by cross hatching in the drawing, is provided on the core constituting plates 12, whereby the core laminate 101 composed of three blocks 13 separated by the separation layers 100 is formed (ST103). In other words, the core laminate forming step is a step in which the core constituting plates 12 are stacked such that, for each of the multiple blocks 13 each composed of a predetermined number of core constituting plates 12, a separation layer 100 is provided to be interposed between the adjacent core constituting plates 12, thereby to form the core laminate 101.

More specifically, as shown in FIG. 5, first of all, lower end portions of the slot guides 32 are fitted into predetermined ones of the slot correspondence holes 59 of the lower plate 26 in the holding jig 21. In this case, it is not necessary for the slot guides 32 to be fitted into the all slot correspondence holes 59. at least In the holding jig 21, it is only required that at least the movement of each divided iron core piece 11 in the circumferential direction is restricted by the slot guides 32. Thereby, the circumferential positions of the core constituting plates 12 composed of the multiple divided iron core pieces 11 are fixed.

On the holding jig 21 in this state, the divided iron core pieces 11 are placed in order from above the slot guides 32, thereby to be stacked at predetermined positions. At this time, in some of the holes of the divided iron core pieces 11 (the holes that later form the slots 4), corresponding slot guides 32 are inserted sequentially.

Note that in FIG. 5, illustration of the inner guide posts 30 and the outer guide posts 31 is omitted to more clearly show the configuration of the slot guides 32 in the holding jig 21. Actually, in the holding jig 21, in addition to the slot guides 32 described above, the lower end portions of the inner guide posts 30 are fitted in the inner guide holes 55 of the lower plate 26, and the lower end portions of the outer guide posts 31 are fitted in the outer guide holes 56 of the lower plate 26.

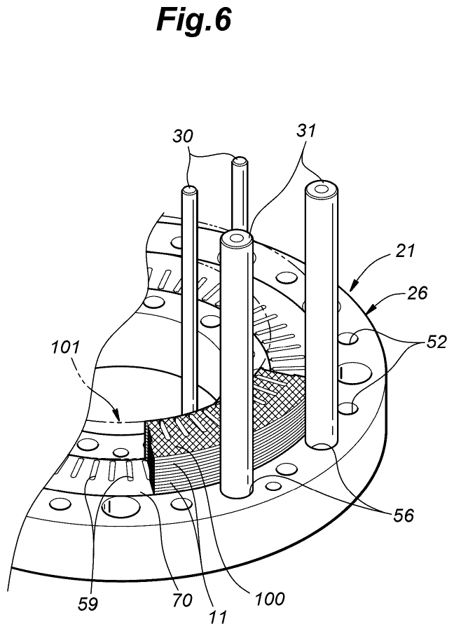

More specifically, as shown in FIG. 6, when each divided iron core piece 11 is placed on the holding jig 21, the downward movement of the divided iron core piece 11 is guided by the inner guide post 30 and the outer guide post 31 corresponding thereto. At this time, an inner circumferential surface and an outer circumferential surface of each divided iron core piece 11 respectively contact (or slidably contact) the inner guide post 30 and the outer guide post 31. Thereby, movement of each divided iron core piece 11 in the radial direction is restricted.

Note that in FIG. 6, only two sets of the inner guide post 30 and the outer guide post 31 for guiding the movement of the divided iron core pieces 11 that are illustrated are shown. Also, as opposed to FIG. 5, illustration of the slot guides 32 is omitted in FIG. 6 to more clearly show the configuration of the inner guide posts 30 and the outer guide posts 31 in the holding jig 21.

Between the bottom surface of the core laminate 101 (namely, the divided iron core piece 11 in the lowermost layer) and the upper surface of the lower plate 26, a release paper (release sheet) 70 having a circular annular shape is interposed. A known material which is coated with silicon or the like and to which an adhesive agent is hard to adhere can be used as the release paper 70. Also, the release paper 70 has substantially the same shape as the core laminate 101 in plan view. Though the illustration is omitted, a release paper similar to the release paper 70 is also interposed between the upper surface of the core laminate 101 (namely, the divided iron core piece 11 in the uppermost layer) and the lower surface of the upper plate 25. Thereby, in a step of removing the holding jig 21 (step ST114) which is executed later, removal of the holding jig 21 from the core laminate 101 (namely, the laminated core 1) is facilitated.

Each time a predetermined number of the core constituting plates 12 each configured by multiple divided iron core pieces 11 are stacked on the lower plate 26, a separation layer 100 is formed on the uppermost core constituting plate 12 except for the one that is stacked the last.

Each separation layer 100 is a layer for prohibiting (suppressing) adhesion between the core constituting plates 12 by the later-described primary adhesive agent 86 for adhesively bonding the stacked core constituting plates 12. The separation layer 100 is formed by spreading or spraying a material containing at least one selected from the group consisting of fluorine, silicon, wax, oils and fats, etc. onto the surface of the core constituting plate 12. The separation layer 100 may be constituted of a release paper coated with silicon or the like or an oiled paper pasted on the surface of the core constituting plate 12. In other words, the separation layer 100 may be a layer containing components that inhibit or suppress adhesion of the adhesive agent 86 to the surface of the core constituting plate 12 or adhesive action of the adhesive agent 86.

When the placement of the all divided iron core pieces 11 on the holding jig 21 is completed, in other words, when the core laminate 101 is formed on the lower plate 26, the upper plate 25 is mounted on the formed core laminate 101. Thereby, as shown in FIG. 7, the core laminate 101 is brought into a state sandwiched by the upper plate 25 and the lower plate 26 (hereinafter referred to as a “temporarily held state”).

Note that the number of the core constituting plates 12 constituting each block 13 may be detected by counting the number of the core constituting plates 12 or the number of the core constituting plates 12 resulting in a predetermined weight. Each core constituting plate 12 may be composed of a single continuous plate member having a circular annular shape, instead of multiple divided iron core pieces 11.

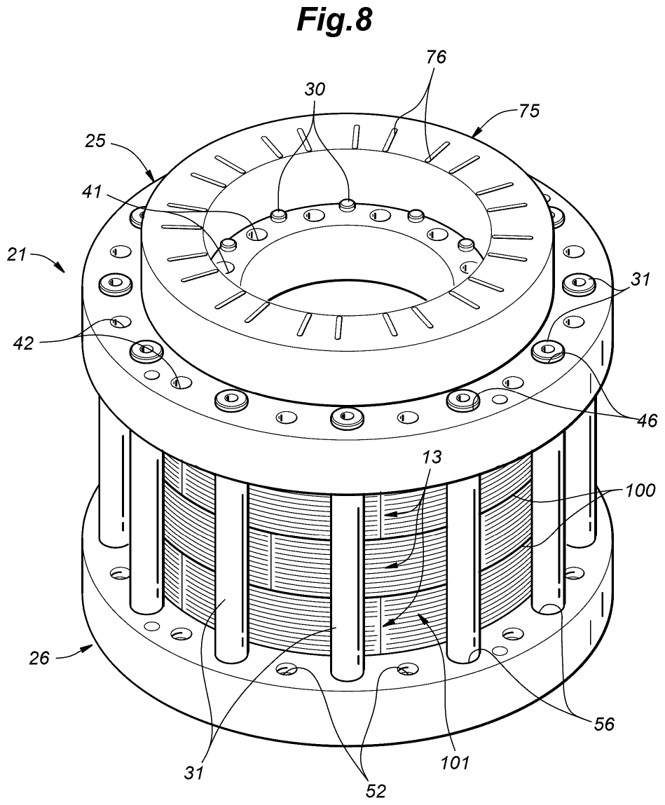

Next, as shown in FIG. 8, a pressing plate 75 is placed on the upper plate 25 to cover the parts of the slot guide 32 protruding from the slot correspondence holes 49 of the upper plate 25. The pressing plate 75 constitutes a part of the holding jig 21.

The pressing plate 75 has a substantially circular annular shape and is disposed between the multiple inner guide posts 30 and the multiple outer guide posts 31 which are respectively arranged in the circumferential direction on the upper plate 25. The pressing plate 75 is provided with multiple slot guide receiving holes 76 in which the upper end portions of the respective slot guides 32 are received. Each slot guide receiving hole 76 has a size and a shape capable of receiving at least the upper end portion of each slot guide 32, and is disposed in a position overlapping with each slot 104 of the core laminate 101 in the axial direction.

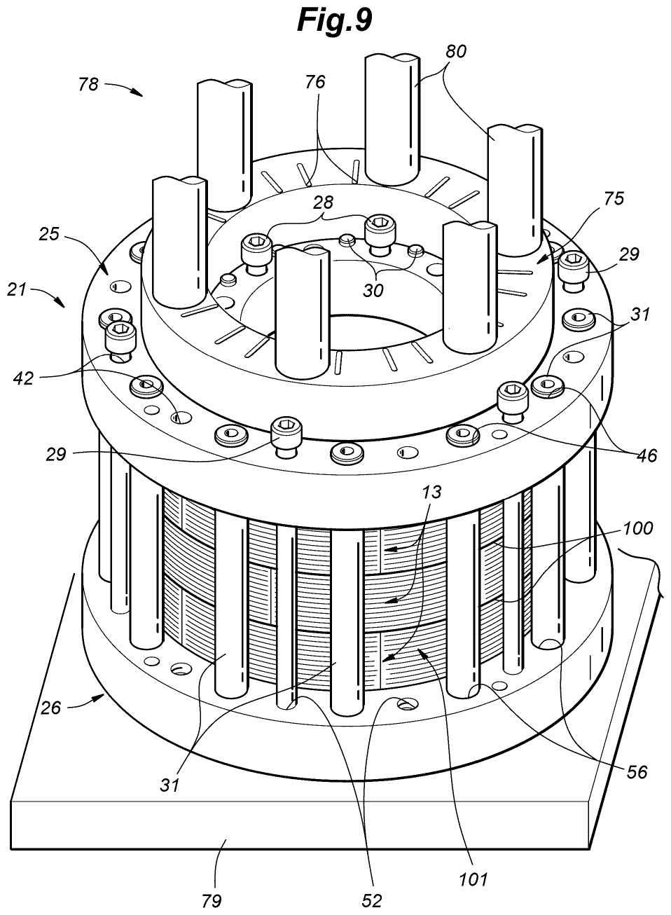

Next, as shown in FIG. 9, in the state in which the core laminate 101 is supported by the holding jig 21, the core laminate 101 is pressed in the stacking direction (axial direction) by multiple pressing rods 80 (ST104).

More specifically, the core laminate 101 temporarily held by the holding jig 21 is disposed on a mounting table 79 in a pressing device 78 and is pressed by the multiple pressing rods 80 in this state. The multiple pressing rods 80 are arranged at equal intervals in the circumferential direction. At this time, each pressing rod 80 is driven downward (namely, toward the mounting table 79) with a predetermined force with the lower end thereof being in contact with a flat upper surface of the pressing plate 75. Thereby, the core laminate 101 is pressed in the stacking direction in the state sandwiched by the upper plate 25 and the lower plate 26, and the thickness of the whole core laminate 101 and the gaps between the core constituting plates 12 adjacent to each other in the axial direction are adjusted.

In the state in which the core laminate 101 is pressed by the pressing device 78, the inner bolts 28 and the outer bolts 29 which are temporarily inserted in the inner bolt holes 41, 51 and the outer bolt holes 42, 52 are tightened. Thereby, in the state in which the thickness of the whole core laminate 101 and the gaps between the core constituting plates 12 are properly adjusted, the upper plate 25 and the lower plate 26 are fixed via a predetermined distance.

Thereafter, the pressing plate 75 is removed, and further, the all slot guides 32 are removed. At this time, the slot guides 32 are pulled out upward from the upper plate 25. Thereby, the formation process of the core laminate 101 ends, and the core laminate 101 is put in the state held by the holding jig 21. Thus, the holding of the core laminate 101 by the holding jig 21 is performed in the state in which the core laminate 101 is pressed in the stacking direction while the displacement in the direction perpendicular to the stacking direction is restricted.

Next, a primary adhesion step of applying the adhesive agent 86 (primary adhesive agent) to the core laminate 101 held by the holding jig 21 is executed (ST105).

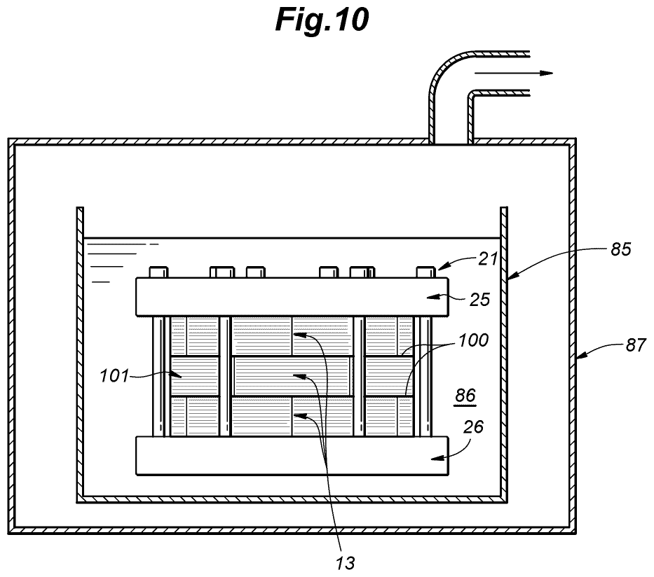

In the primary adhesion step, as shown in FIG. 10, the core laminate 101 held by the holding jig 21 is immersed in an adhesive agent bath (adhesive container) 85 filled with the adhesive agent 86 in a liquid state, namely, in the adhesive agent bath 85 containing an adhesive agent 88. In this state, the adhesive agent bath 85 is set in a vacuum device 87 and the inside of the vacuum device 87 is brought into a vacuum (reduced pressure) state by a vacuum pump not shown in the drawing. Thereby, the core laminate 101 held by the holding jig 21 such that the displacement in the direction perpendicular to the stacking direction of the core constituting plate 12 is restricted is impregnated with (adhered by) the adhesive agent 86. In other words, in the core laminate 101, the adhesive agent 86 penetrates into the boundaries between the divided iron core pieces 11 that are adjacent to each other in the circumferential direction and the boundaries (namely, minute gaps) between the divided iron core pieces 11 that are adjacent to each other in the up-down direction (stacking direction), and the adhesive agent 86 adheres to the lamination surfaces of the core laminate 101. As the adhesive agent 86, a known thermosetting adhesive agent such as epoxy-based adhesive agent can be used.

Next, a cleaning step of cleaning the core laminate 101 is executed to remove excess adhesive agent 86 from the core laminate 101 (ST106). The excess adhesive agent 86 to be removed in the cleaning step may include the adhesive agent adhering to the outer circumferential surface of the core laminate 101.

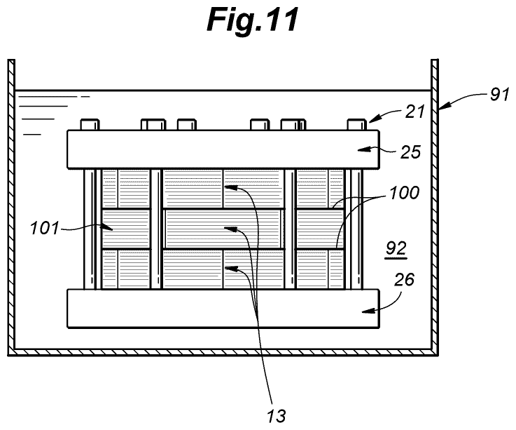

In the cleaning step, as shown in FIG. 11, the core laminate 101 held by the holding jig 21 is immersed in a liquid detergent 92 contained in a cleaning container 91 (detergent bath). Such immersion of the core laminate 101 in the detergent 92 may be performed multiple times, each for a predetermined immersion time, while checking the degree to which the adhesive agent has been removed. At this time, appropriate immersion time and number of times of immersion are set so that the adhesive agent 86 that has penetrated into the core laminate 101 is not excessively removed. For example, acetone, thinner, organic solvent, cleaning solvent, or the like may be used as the detergent.

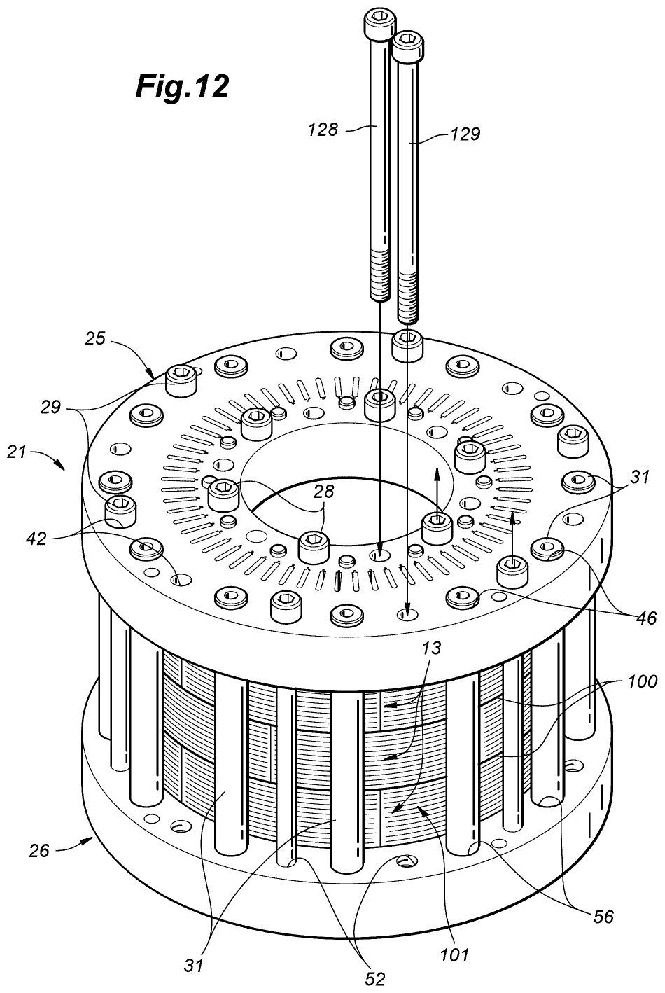

Also, in the cleaning step, the core laminate 101 is once taken out from the cleaning container 91 after being immersed in the detergent 92, and the inner bolts 28 and the outer bolts 29 are removed (replaced with additional bolts 128, 129). More specifically, as shown in FIG. 12, in the above-described laminate formation step, the same number of additional bolts 128 as the inner bolts 28 are inserted in or fastened to the remaining inner bolt holes 41, 51 which the inner bolts 28 are not inserted in nor fastened to. Similarly, the same number of additional bolts 129 as the outer bolts 29 are inserted in or fastened to the remaining outer bolt holes 42, 52 which the outer bolts 29 are not inserted in nor fastened to. Thereby, the additional bolts 128, 129 are inserted in or fastened to the inner bolt holes 41, 51 and the outer bolt holes 42, 52 after being cleaned, and thus, are not affected by the adhesive agent 86. On the other hand, the inner bolts 28 and the outer bolts 29 can avoid being firmly adhered to the upper plate 25 and the lower plate 26 of the holding jig 21 by curing of the adhesive agent 86.

In this case, to stably hold the core laminate 101, the inner bolts 28 and the outer bolts 29 that have been installed are removed after the additional bolts 128, 129 are all installed. Also, to prevent the additional bolts 128, 129 from being tightened excessively, the tightening torque therefor is adjusted.

Next, a primary adhesive agent curing step of curing the adhesive agent 86 that has penetrated into the core laminate 101 is executed (ST107).

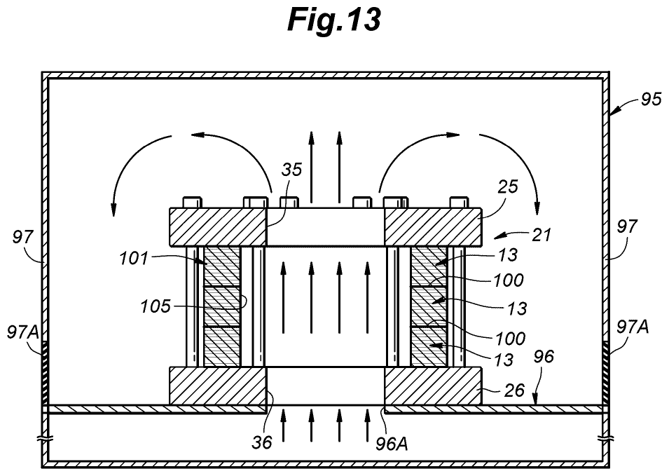

In the primary adhesive agent curing step, as shown in FIG. 13, the core laminate 101 held by the holding jig 21 is heated in the furnace chamber of the heating furnace 95. At this time, the bottom wall 96 of the furnace chamber on which the core laminate 101 is placed is provided with a hot air outlet 96A to send out hot air for heating. At this time, the core laminate 101 is disposed in the furnace chamber such that the center opening 36 of the lower plate 26 of the holding jig 21 that holds it overlaps the hot air outlet 96A.

Thereby, the hot air sent out from the hot air outlet 96A is introduced into the holding jig 21 from the center opening 36 of the lower plate 26, and further, passes upward through the center hole 105 of the core laminate 101 and the center opening 35 of the upper plate 25. Thereafter, the hot air flows around to the outer circumferential surface of the core laminate 101 and is discharged to the outside of the furnace from exhaust outlets 97A provided in a lower portion of a side wall 97 of the furnace chamber. With such a configuration, the heating furnace 95 can evenly heat the entirety of the core laminate 101 with the hot air sent out from the hot air outlet 96A. As the heating furnace 95, a known electric furnace can be used, for example.

After the primary adhesive agent curing step, the core laminate 101 is cooled such that the temperature thereof is returned to a temperature near the room temperature. After the cooling of the core laminate 101 is completed, the inner bolts 28, the outer bolts 29, and the upper plate 25 of the holding jig 21 are removed. Thereby, the pressing of the core laminate 101 is released (ST108).

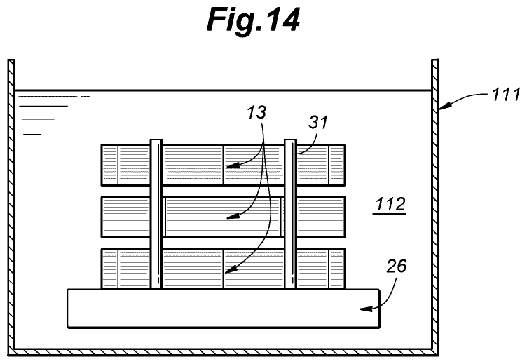

Next, as shown in FIG. 14, a separation layer removal step is executed where the core laminate 101 in which gaps are created between adjacent blocks 13 after the pressing is released is immersed in a cleaning liquid 112 contained in a cleaning container 111 to remove the separation layers 100 (ST109). As the cleaning liquid 112, a cleaning liquid capable of removing the separation layers 100 without affecting the adhesive agent 86 is selected. The removal of the separation layers 100 may be performed by wiping the separation layers 100 with a cloth impregnated with a detergent, a cleaning brush, or the like, other than immersing the core laminate 101 in the cleaning liquid 112.

Next, a re-pressing step is executed where the holding jig 21 is attached again to the core laminate 101 to re-press the core laminate 101 (ST110). The re-pressing step is performed in the same manner as the pressing of the core laminate 101 in ST104 described above. The holding jig (second holding jig) 21 that is used in and after the re-pressing step may be the same as or different from the holding jig (first holding jig) 21 shown in FIG. 2.

Next, a secondary adhesion step of applying the adhesive agent (secondary adhesive agent) 88 to the core laminate 101 held by the holding jig 21 is executed (ST111).

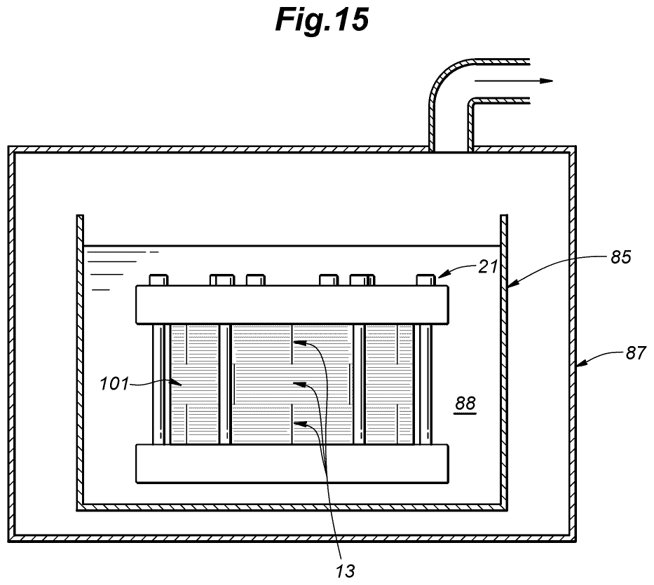

In the secondary adhesion step, as shown in FIG. 15, the core laminate 101 held by the holding jig 21, namely, in the state in which the displacement in the direction perpendicular to the stacking direction is restricted, is immersed in the adhesive agent bath 85 containing the liquid adhesive agent (secondary adhesive agent) 88. In this state, the adhesive agent bath 85 is set in the vacuum device 87, and the inside of the vacuum device 87 is brought into a vacuum (reduced pressure) state by a vacuum pump not shown in the drawing. Thereby, the core laminate 101 held by the holding jig 21 such that the displacement in the direction perpendicular to the stacking direction of the core constituting plate 12 is restricted is impregnated with the adhesive agent 88. In other words, in the core laminate 101, the adhesive agent 88 penetrates into the minute gaps between the adjacent blocks 13 from which the separation layers 100 are removed. Due to this penetration of the adhesive agent 88, the adhesive agent 88 adheres to the lamination surfaces of the core constituting plates 12 facing each other between the adjacent blocks 13. As the adhesive agent 88, a thermosetting adhesive identical with the adhesive agent 86 can be used.

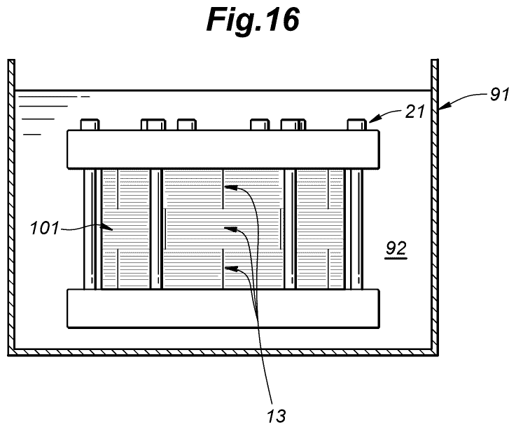

Next, as shown in FIG. 16, the core laminate 101 held by the holding jig 21 is cleaned by a cleaning step same as the cleaning step in ST106 in which the cleaning container 91 is used (ST112).

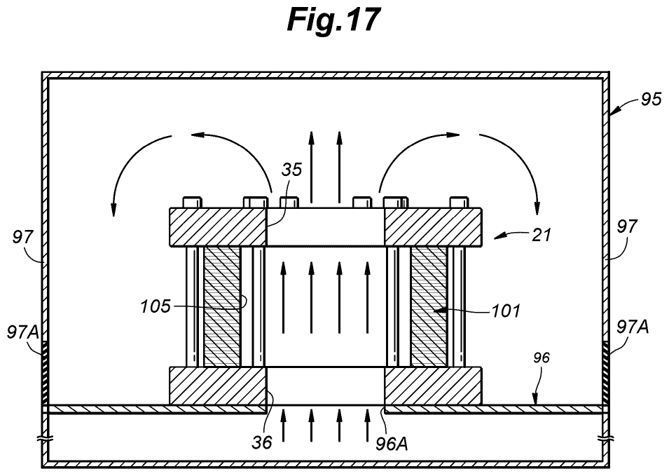

Next, a secondary adhesive agent curing step is executed where the adhesive agent 88 that has penetrated between the blocks 13 of the core laminate 101 is cured while the core laminate 101 is held by the holding jig 21 (ST113). Similarly to the primary adhesive agent curing step, the secondary adhesive agent curing step is carried out by heating using the heating furnace 95 shown in FIG. 17.

Note that the primary adhesive agent 86 and the secondary adhesive agent 88 may be the same or may be different. The primary adhesive agent 86 and the secondary adhesive agent 88 are not limited to thermosetting adhesive agents and may be room temperature curing adhesive agents such as instant adhesive agents so long as they provide adhesion strength required for the laminated core 1.

After the secondary adhesive agent curing step is finished, a holding jig removal step of removing the holding jig from the core laminate 101 is executed (ST114). Thereby, the laminated core 1 in which a predetermined number of core constituting plates 12 are stacked and adhesively bonded is completed.

In the manufacturing method for the laminated core 1 described above, the stacking and adhesive bonding are carried out for each of the divided multiple blocks 13 individually, and the multiple blocks 13 for which the stacking and adhesive bonding have been finished are joined to form the laminated core 1. In other words, the laminated core 1 is configured by a stack of the multiple blocks 13 which are each composed of multiple core constituting plates 12 and which are separated by the separation layers 100.

In this laminated core 1, due to contraction of the adhesive agent layers 14 (see FIG. 1) between the core constituting plates 12 when curing, deformation of the laminated core 1 into a concave shape in the stacking direction occurs individually for each block 13 which is composed of a smaller number of stacked core constituting plates 12 than the number of stacked core constituting plates 12 of the entire core. Therefore, in the laminated core 1 configured by a stack of the multiple blocks 13, the deformation into the concave shape in the stacking direction becomes smaller than the case where the entirety of the laminated core 1 is formed all at once by stacking and adhesive bonding.

Thus, according to the manufacturing method for the laminated core 1 described above, the laminated core 1 with small deformation can be manufactured easily and reliably even when the laminated core 1 is composed of a large number of stacked core constituting plates 12.

### Second Embodiment

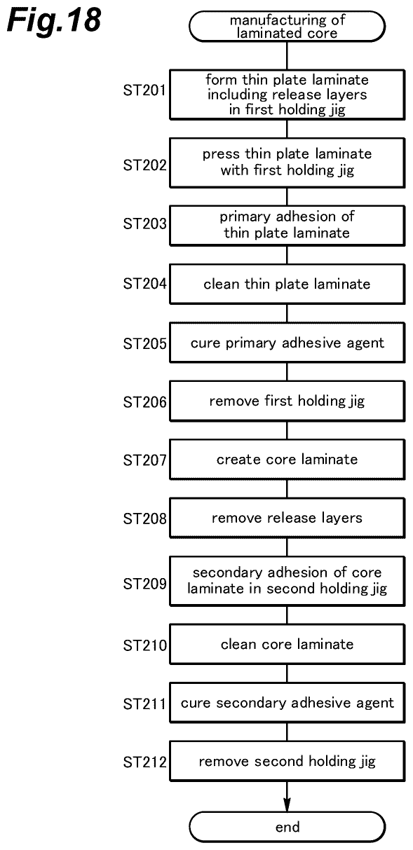

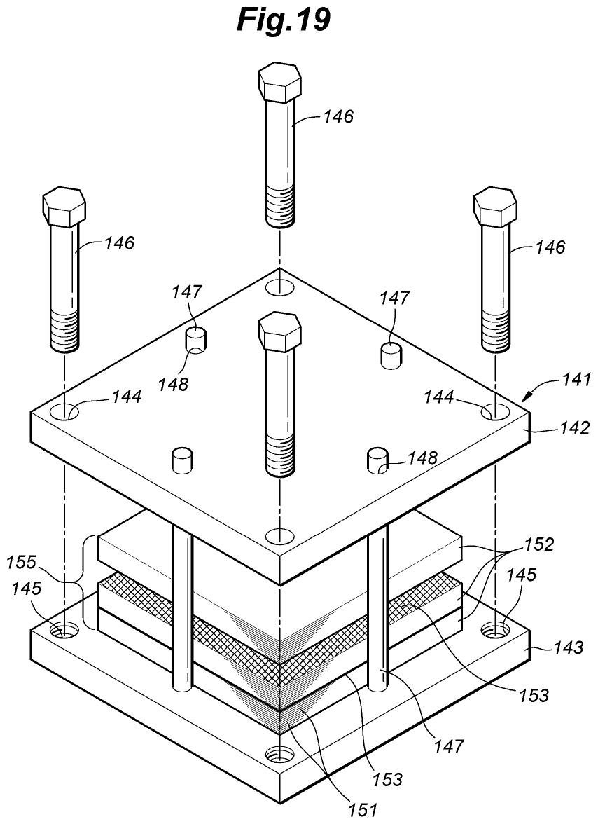

Next, a second embodiment will be described with reference to FIGS. 18 to 22. Note that the second embodiment is the same as the above-described first embodiment other than the matters particularly mentioned below. Also, in FIGS. 19 to 22, the parts corresponding to those in FIG. 1 are denoted by the same reference signs as in FIG. 1, and the description thereof is omitted.

FIG. 18 is a flowchart showing a manufacturing process (ST201 to ST212) of a laminated core 1 according to the second embodiment.

In the manufacturing process for the laminated core 1 of the second embodiment, first, as shown in FIG. 19, a thin plate stacking step is executed where each time a predetermined number of rectangular thin plates 151, each formed of an electromagnetic steel sheet or the like, are stacked on a first holding jig 141, namely, for each block 152, a separation layer 153 is interposed between adjacent thin plates 151 thereby to form a thin plate laminate 155 (ST201).

As shown in FIG. 19, the first holding jig 141 has an upper plate 142, a lower plate 143, multiple fastening bolts 146, and multiple guide posts 147.

The upper plate 142 has a flat, rectangular lower surface that contacts the upper surface of the thin plate laminate 155. Each corner part of the upper plate 142 is provided with a bolt hole 144 in which the fastening bolt 146 is inserted. An intermediate portion of each side of the upper plate 142 is provided with a guide hole 148 in which the guide post 147 is fitted. The bolt holes 144 and the guide holes 148 are each a through hole vertically penetrating the upper plate 142.

The lower plate 143 has a flat, rectangular upper surface configured to contact the lower surface of the thin plate laminate 155. Each corner part of the lower plate 143 is provided with a screw hole 145 into which the fastening bolt 146 is screwed. In an intermediate portion of each side of the lower plate 143, a guide post 147 is implanted vertically. Each guide post 147 contacts the corresponding outer side of the rectangular thin plates 151 placed on the lower plate 143, and restricts displacement of the thin plates 151 on the lower plate 143 in a direction perpendicular to the stacking direction of the thin plates 151. Due to this restriction, the multiple thin plates 151 are stacked on the lower plate 143 in an aligned manner.

Each time a predetermined number of the thin plates 151 are stacked on the lower plate 143, a separation layer 153 is formed on the uppermost thin plate 151 except for the one that is stacked the last.

Similarly to the separation layers 100 of the first embodiment, each separation layer 153 is a layer for prohibiting (suppressing) adhesion between the thin plates 151 by the later-described adhesive agent (primary adhesive agent) 86 for and adhesively bonding the stacked thin plates 151. The separation layer 153 is formed by spreading or spraying a material containing at least one selected from the group consisting of fluorine, silicon, wax, oils and fats, etc. onto the surface of the thin plate 151. The separation layer 153 may be constituted of a release paper coated with silicon or the like or an oiled paper pasted on the surface of the core constituting plate 12. In other words, the separation layer 153 may be a layer containing components that inhibit or suppress adhesion of the adhesive agent 86 to the surface of the thin plate 151 or adhesive action of the adhesive agent 86.

Thereby, multiple blocks 152 are created in which the laminated thin plates 151 are divided by the separation layers 153.

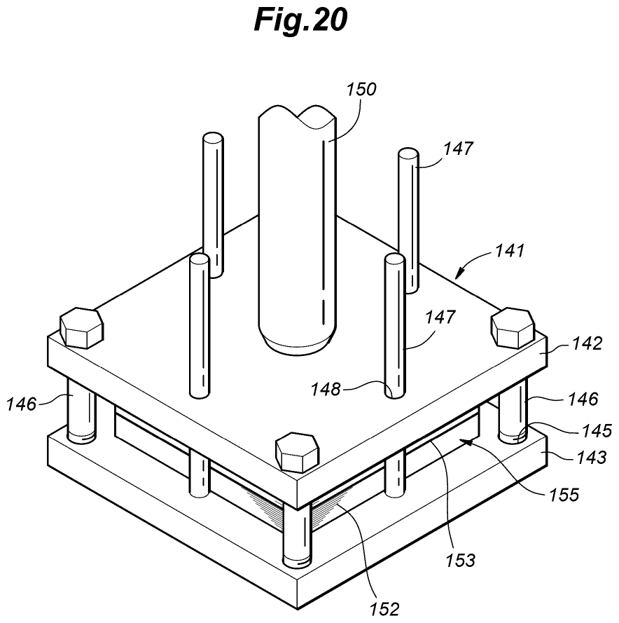

As shown in FIG. 20, each guide post 147 is fitted in the corresponding guide hole 148, and each fastening bolt 146 is passed through the corresponding bolt hole 144 and is threadably engaged with the corresponding screw hole 145, whereby the thin plate laminate 155 is sandwiched by the upper plate 142 and the lower plate 143. Thereby, the thin plate laminate 155 is held by the first holding jig 141, and the displacement in the direction perpendicular to the stacking direction of the thin plates 151 is restricted.

Next, a pressing step is executed where the thin plate laminate 155 held by the first holding jig 141 is pressed by a pressing rod 150 in the stacking direction (ST202). With the pressing rod 150 driving the upper plate 142 toward the lower plate 143, the thin plate laminate 155 is pressed in the stacking direction in the state sandwiched by the upper plate 142 and the lower plate 143, and the thickness of the whole thin plate laminate 155 and the gaps between the thin plates 151 adjacent to each other in the axial direction are adjusted.

In this pressed state, each fastening bolt 146 is tightened. Thereby, in the state in which the thickness of the whole thin plate laminate 155 and the gaps between the thin plates 151 are properly adjusted, the upper plate 142 and the lower plate 143 are fixed via a predetermined distance.

Next, a primary adhesion step of applying the adhesive agent (primary adhesive agent) 86 to the thin plate laminate 155 held by the first holding jig 141 is executed (ST203).

In the primary adhesion step, similarly to the primary adhesion step in ST105 of the first embodiment, the thin plate laminate 155 held by the first holding jig 141 is immersed in the adhesive agent bath 85 filled with the adhesive agent 86 in the liquid state. In this state, the adhesive agent bath 85 is set in the vacuum device 87 and the inside of the vacuum device 87 is brought into a vacuum (reduced pressure) state by a vacuum pump not shown in the drawing. Thereby, the thin plate laminate 155 whose displacement in the direction perpendicular to the stacking direction of the thin plates 151 is restricted by the first holding jig 141 is impregnated with (adhered by) the adhesive agent 86.

Next, a cleaning step of cleaning the thin plate laminate 155 is executed to remove excess adhesive agent 86 from the thin plate laminate 155 (ST204). Similarly to the cleaning step in ST106 of the first embodiment, the cleaning step is performed by immersing the thin plate laminate 155 in the liquid detergent 92 contained in the cleaning container 91.

Next, a primary adhesive agent curing step of curing the adhesive agent 86 that has penetrated into thin plate laminate 155 is executed (ST205). Similarly to the primary adhesive agent curing step in ST107 of the first embodiment, the primary adhesive agent curing step is performed by heating the thin plate laminate 155 in the furnace chamber of the heating furnace 95 shown in FIG. 13.

After the thermosetting of the primary adhesive agent 86 in the thin plate laminate 155 is completed, the first holding jig 141 is removed from the thin plate laminate 155 (ST206).

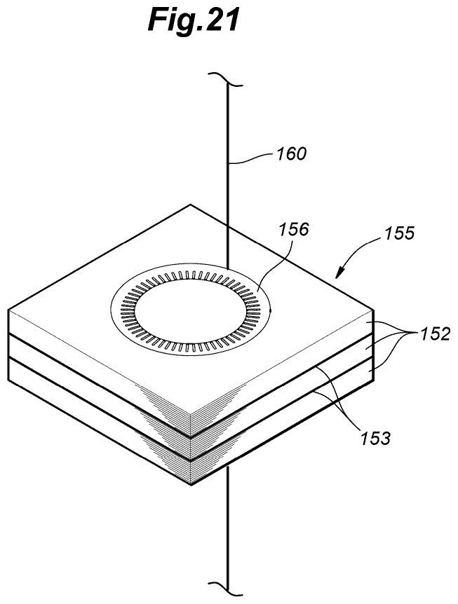

Next, as shown in FIG. 21, a core constituting body creating step is executed where a core constituting body 156 having a predetermined shape is created from the thin plate laminate 155 (ST207). The core constituting body creating step is performed by cutting out the core constituting body 156 having a predetermined shape from the thin plate laminate 155 by wire electrical discharge machining using a wire electrode 160 that penetrates the thin plate laminate 155 in the stacking direction. The creation of the core constituting body 156 in the core constituting body creating step is not limited to the wire electrical discharge machining, and may be performed by a process including an outer shape forming step using electron beam machining, laser beam machining, or the like.

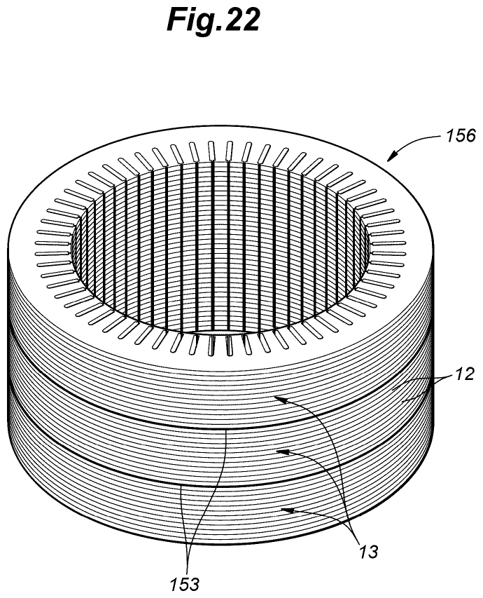

As shown in FIG. 22, the core constituting body 156 cut out from the thin plate laminate 155 forms a laminate in which multiple blocks 13, each composed of multiple core constituting plates 12 joined together by adhesion, are separated by the separation layers 153. This core constituting body 156 differs from the first embodiment in that the core constituting plates 12 that are not divided and have a continuous, circular annular shape are stacked and adhesively bonded, but is substantially the same as the first embodiment with respect to the feature that it is configured by a stack of the multiple blocks 13 which are each composed of multiple core constituting plates 12 and which are separated by the separation layers 153.

Next, a separation layer removal step of removing the separation layers 153 of the core constituting body 156 is executed (ST208). Similarly to the separation layer removal step in ST109 of the first embodiment, the separation layer removal step may be performed by immersing the core constituting body 156 in the cleaning liquid 112 contained in the cleaning container 111 shown in FIG. 14. In this case also, a cleaning liquid capable of removing the separation layers 153 without affecting the adhesive agent 86 is selected as the cleaning liquid 112. The removal of the separation layers 153 may be performed by wiping the separation layers 153 with a cloth impregnated with a detergent, a cleaning brush, or the like, other than immersing the core constituting body 156 in the cleaning liquid 112.

Next, similarly to ST110 and ST111 of the first embodiment, the core constituting body 156 is mounted to a holding jig (second holding jig) 21 equivalent to the holding jig 21 of the first embodiment to press the core constituting body 156, and the core constituting body 156 held by the holding jig 21 is immersed in the adhesive agent bath 85 (see FIG. 15) filled with a liquid adhesive agent (secondary adhesive agent) 88 (ST209). In this state, the adhesive agent bath 85 is set in the vacuum device 87 and the inside of the vacuum device 87 is brought into a vacuum (reduced pressure) state by a vacuum pump not shown in the drawing (see FIG. 15).

Thereby, the core constituting body 156 is impregnated with the adhesive agent 88 and the adhesive agent (secondary adhesive agent) 88 is applied to the lamination surfaces between the adjacent blocks 13. In other words, in the core constituting body 156, the adhesive agent 88 penetrates into the minute gaps between the adjacent blocks 13 from which the separation layers 153 are removed, and the adhesive agent 88 adheres to the lamination surfaces of the core constituting plates 12 facing each other between the adjacent blocks 13. As the adhesive agent 88, a thermosetting adhesive identical with the adhesive agent 86 can be used.

Next, the core constituting body 156 held by the holding jig 21 is cleaned by a cleaning step same as the cleaning step in ST106 in which the cleaning container 91 is used (ST210).

Next, a secondary adhesive agent curing step of curing the adhesive agent 88 that has penetrated between the blocks 13 of the core constituting body 156 is executed (ST211). Similarly to the primary adhesive agent curing step, the secondary adhesive agent curing step is carried out by heating using the heating furnace 95, as shown in FIG. 17.

Note that in the second embodiment also, the primary adhesive agent 86 and the secondary adhesive agent 88 may be the same or may be different, as in the first embodiment. The primary adhesive agent 86 and the secondary adhesive agent 88 are not limited to thermosetting adhesive agents and may be room temperature curing adhesive agents such as instant adhesive agents so long as they provide adhesion strength required for the laminated core 1.

After the secondary adhesive agent curing step is finished, a holding jig removal step of removing the holding jig from the core constituting body 156 is executed (ST212). Thereby, the laminated core 1 in which a predetermined number of core constituting plates 12 are stacked and adhesively bonded is completed.

In the manufacturing method for the laminated core 1 described above, the stacking and adhesive bonding are carried out for each of the divided multiple blocks 13 individually, and the multiple blocks 13 for which the stacking and adhesive bonding have been finished are joined to form the laminated core 1. In other words, the laminated core 1 is configured by a stack of the multiple blocks 13 which are each composed of multiple core constituting plates 12 and which are separated by the separation layers 100.

In this laminated core 1, due to contraction of the adhesive agent layers 14 (see FIG. 1) between the core constituting plates 12 when curing, deformation of the laminated core 1 into a concave shape in the stacking direction occurs individually for each block 13 which is composed of a smaller number of stacked core constituting plates 12 than the number of stacked core constituting plates 12 of the entire core. Therefore, in the laminated core 1 configured by a stack of the multiple blocks 13, the deformation into the concave shape in the stacking direction becomes smaller than the case where the entirety of the laminated core 1 is formed all at once by stacking and adhesive bonding.

Thus, with the manufacturing method for the laminated core 1 according to the second embodiment, the laminated core 1 with small deformation can be manufactured easily and reliably even when the laminated core 1 is composed of a large number of stacked core constituting plates 12.

In the second embodiment also, each core constituting plate 12 may be composed of multiple divided iron core pieces 11, as in the first embodiment. In this case, multiple divided iron core pieces 11 are created in ST207.

The present invention has been described in the foregoing with respect to specific embodiments, but these embodiments are mere examples and the present invention is not limited by these embodiments.

For example, the application of the adhesive agent 86, 88 to the core constituting plates 12 and the thin plates 151 may be performed by spreading or spraying the adhesive agent 86, 88 onto the core constituting plates 12 and the thin plate 151, other than the method of immersing the core laminate 101 and the thin plate laminate 155 in the adhesive agent 86, 88 contained in the adhesive agent bath 85 in a reduced pressure state.

The arrangement of the divided iron core pieces 11 in the first embodiment may be other than the arrangement in which the boundaries 11A are staggered, and may be an arrangement in which the boundaries 11A are in a straight line throughout the region in the stacking direction. Also, the present invention may be used in a divided iron core composed of divided iron core pieces 11 that are stacked and adhesively bonded without being arranged in an annular shape.

The laminated core 1 according to the present invention is not only used in a motor but may be used in rotating electric machinery such as an electric generator having a similar configuration thereto.

Note that not all of the components of the manufacturing method for the laminated core and the holding jig for manufacturing the laminated core according to the present invention shown in the above embodiments are necessarily indispensable, and they may be selectively adopted as appropriate as long as not departing from the scope of the present invention.

### LIST OF REFERENCE NUMERALS

1: laminated core
2: yoke
3: teeth
4: slot
5: center hole
10: strip
11: divided iron core piece
11A: boundary
12: core constituting plate
13: block
14: adhesive agent layer
21: holding jig (first holding jig, second holding jig)
25: upper plate
26: lower plate
28: inner bolt
29: outer bolt
30: inner guide post
31: outer guide post
32: slot guide
35: center opening
36: center opening
41: inner bolt hole
42: outer bolt hole
45: inner guide hole
46: outer guide hole
49: slot correspondence hole
51: inner bolt hole
52: outer bolt hole
55: inner guide hole
56: outer guide hole
59: slot correspondence hole
61: head
62: head
63: threaded part
64: threaded part
65: screw hole
68: locking hole
70: release paper
75: pressing plate
76: slot guide receiving hole
78: pressing device
79: mounting table
80: pressing rod
85: adhesive agent bath
86: adhesive agent (primary adhesive agent)
87: vacuum device
88: adhesive agent (secondary adhesive agent)
91: cleaning container
92: detergent
95: heating furnace
96: bottom wall
96A: hot air outlet
97: side wall
97A: exhaust outlet
100: separation layer
101: core laminate
104: slot
105: center hole
111: cleaning container
112: cleaning liquid
128: bolt
129 bolt
141: first holding jig
142: upper plate
143: lower plate
144: bolt hole
145: screw hole
146: fastening bolt
147: guide post
148: guide hole
150: pressing rod
151: thin plate
152: block
153: separation layer
155: thin plate laminate
156: core constituting body
160: wire electrode

1. A manufacturing method for a laminated core in which multiple core constituting plates are stacked and adhesively bonded, the manufacturing method comprising:
a core constituting plate creating step of creating multiple core constituting plates, each having a predetermined shape, from a thin plate;
a core laminate forming step of forming a core laminate by stacking the core constituting plates such that, for each of multiple blocks each consisting of a predetermined number of the core constituting plates, a separation layer is interposed between adjacent ones of the core constituting plates;
a primary adhesion step of applying a primary adhesive agent to the core laminate while the core laminate is held by a first holding jig;
a primary adhesive agent curing step of curing the primary adhesive agent applied to the core laminate while the core laminate is held by the first holding jig;
a separation layer removal step of removing the separation layers;
a secondary adhesion step of applying a secondary adhesive agent to lamination surfaces between the blocks; and
a secondary adhesive agent curing step of curing the secondary adhesive agent while the core laminate is held by a second holding jig.

2. The manufacturing method for the laminated core according to claim 1, wherein holding of the core laminate by the first holding jig and the second holding jig is performed in a state in which the core laminate is pressed in a stacking direction while displacement in a direction perpendicular to the stacking direction is restricted.

3. The manufacturing method for the laminated core according to claim 1, wherein the primary adhesion step includes a step of immersing the core laminate in an adhesive agent bath containing a liquid adhesive and a step of reducing pressure inside the adhesive agent bath.

4. A manufacturing method for a laminated core in which multiple core constituting plates are stacked and adhesively bonded, the manufacturing method comprising:
a thin plate stacking step of forming a thin plate laminate by stacking thin plates such that, for each of multiple blocks each consisting of a predetermined number of the thin plates, a separation layer is interposed between adjacent ones of the thin plates;
a primary adhesion step of applying a primary adhesive agent to the thin plate laminate while the thin plate laminate is held by a first holding jig;
a primary adhesive agent curing step of curing the primary adhesive agent applied to the thin plate laminate while the thin plate laminate is held by the first holding jig;
a core constituting body creating step of creating a core constituting body having a predetermined shape from the thin plate laminate;
a separation layer removal step of removing the separation layers;
a secondary adhesion step of applying a secondary adhesive agent to lamination surfaces between the blocks; and
a secondary adhesive agent curing step of curing the secondary adhesive agent while the core constituting body is held by a second holding jig.

5. The manufacturing method for the laminated core according to claim 4, wherein holding of the thin plate laminate by the first holding jig is performed in a state in which the thin plate laminate is pressed in a stacking direction while displacement in a direction perpendicular to the stacking direction is restricted, and holding of the core constituting body by the second holding jig is performed in a state in which the core constituting body is pressed in the stacking direction while displacement in the direction perpendicular to the stacking direction is restricted.

6. The manufacturing method for the laminated core according to claim 4, wherein the primary adhesion step includes a step of immersing the thin plate laminate in an adhesive agent bath containing the primary adhesive agent in a liquid state and a step of reducing pressure inside the adhesive agent bath.

7. The manufacturing method for the laminated core according to claim 4, wherein the core constituting body creating step includes an outer shape forming step that uses wire electrical discharge machining, electron beam machining, or laser beam machining.

8. The manufacturing method for the laminated core according to claim 1, wherein the separation layer includes at least one selected from the group consisting of fluorine, silicon, wax, and oils and fats.
